(19) United States
(12) Patent Application Publication
(10) Pub. No.: US 2010/0281396 A1
(43) Pub. Date: Nov. 4, 2010

(54) METHOD FOR CONTROLLING USER REPRESENTATIONS, CORRESPONDING DEVICE AND COMPUTER PROGRAM PRODUCT

(75) Inventors: Yves Scotto D'Apollonia, Thorigne-Fouillard (FR); Herve Texier, Noyal Chatillon Sur Seiche (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: FRANCE TELECOM, Paris (FR)

(21) Appl. No.: 12/808,955

(22) PCT Filed: Dec. 12, 2008
(86) PCT No.: PCT/FR2008/052297

§ 371 Date: Jun. 17, 2010

(30) Foreign Application Priority Data
Dec. 17, 2007 (FR) 0759887

(51) Int. Cl. G06F 3/00

(52) U.S. Cl. 715/748; 715/757

(57) ABSTRACT

A method is provided for monitoring a representation of a user in a virtual environment. The method includes: a step of continuous supervision of a state of transfer of data between a terminal of said user and an entity for management of said virtual environment; a step of adaptation of a behaviour of said representation following a modification of said data transfer state.

### CROSS-REFERENCE TO RELATED APPLICATIONS

This Application is a Section 371 National Stage Application of International Application No. PCT/FR2008/052297, filed Dec. 12, 2008 and published as WO 2009/083681 on Jul. 9, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT None.

### FIELD OF THE DISCLOSURE

The present disclosure pertains to the information-processing related management of virtual environments such as “virtual worlds”, for example enabling users to meet one another virtually through their respective terminals and communications networks. Here below in this document, the expressions “virtual environment” or “virtual world” will be used equally without distinction, without in any way thereby affecting the understanding of the disclosure.

A virtual environment can be seen as a representation of a particular universe within which users of the real world are present in the form of avatars. An avatar is a user's representation defined by means of a set of parameters. A representation of this kind can take the form especially of an image or a moving object.

Within a virtual environment known as an “immersive” environment, such a representation generally corresponds to the result of computations, sometimes complex ones, made on the basis of various parameters proper to a user. Such a representation may be a 2D or 3D representation and may act in real time both as a function of parameters and/or actions performed by the user in the virtual environment and as a function of actions performed by other users (or by their respective avatars) acting within a same virtual environment. A virtual environment is said to be “immersive” when the user is plunged into this environment by means of a representation of a space and of users, for example in three dimensions. The term used then is “user immersion”.

The present disclosure relates more particularly to the management of instances of disconnection and re-connection of users of communications networks and therefore to the management of representations of these users within virtual worlds during the disconnection and re-connection phases.

### BACKGROUND OF THE DISCLOSURE

In a virtual world, each user has a representation (for example in the form of an avatar) which he drives in an immersive situation. Each of the motions of the body and the movements of a representation in the virtual world is passed on into the vision of the other users present in the world. The viewing of these movements must be fluid in order to provoke the desire to continue in the immersive situation. The operation generally relies on common apparatuses (called servers) to which the apparatuses (called clients) of each user gets connected by means of a communications network.

When there is an untimely break in the communications link or when there is an untimely stoppage of the server apparatuses, the user's client station no longer has any updates available on motions and movements (i.e. behavior) of the other users. Indeed, the interruption of the transfer of data that results from this break or this stoppage means that the client can no longer receive updating information. The immersive world is frozen until the communication link is restored. In other words, nothing happens any longer in the virtual world which is “blocked” as it were. Restoration then provides the information needed to reposition the representations of the other users in the user's field of vision in the immersive world.

However, when normality returns, the representations of the other users are repositioned at the places that they ought to be occupying, given the changes undergone by these other users during the interruption (thus causing the representations to “jump” to their current positions).

This operation, related to the state of data transfer (interrupted or in progress) has the drawback of eliminating the impression of immersion, especially when an error message appears in order to report something that the user has already noted (namely the interruption).

The sudden movement of the representations of the other users, who return to their right position when the link is restored, also impairs the impression of immersion. The interest of continuing the immersive experience diminishes until ultimately it causes the user to leave.

To date, no solution has been found to overcome these drawbacks and especially to overcome the disappointment that untimely interruptions in service provoke in the user.

Furthermore, the quality of service proposed as a standard within the internet network and which is expressed in terms of a “best effort” approach (i.e. the apparatuses of the network will do their best to convey data from one point to another) does not prevent such interruptions both in the apparatuses of the network (routers, concentrators, gateways etc) and in the central apparatuses (servers, management entities).

### SUMMARY

The approach proposed by an exemplary embodiment of the invention does not have these prior-art drawbacks. An embodiment pertains to a method for controlling a user's representation in a virtual environment.

According to an embodiment of the invention, such a method comprises:
a step of continuous supervision of a state of transfer of data between a terminal of said user and an entity for managing said virtual environment;
a step for adapting a behavior of said representation following a modification of said state of data transfer.

Thus, an embodiment of the invention mitigates the drawbacks related to untimely cuts and restoration of communications links and to stoppages and restarting of hardware apparatuses. Indeed, during an interruption in data transfer, the method of an embodiment of the invention makes it possible to take over control of the representation of the user so that, for the other users immersed in the virtual world, the representation of the user who is interrupted does not remain frozen. This control of representation is automatic. It means that no action on the part of any user is needed to implement it. Thus, even in the event of interruption, life continues within the virtual world without its being possible for the other detectors who have stayed connected to spot any deterioration in service within the virtual environment.

Conversely, for the user who has been interrupted, the method of an embodiment of the invention makes it possible to take control of the representations of the users who might be in his field of vision so that they do not remain frozen. This control is also automatic.

Indeed, depending on the mechanisms of the prior art, the entity for managing the representation of the users transmits data (previously received) for putting representations into motion to the users' terminals in order to update the virtual world and the motions/interactions of the representations in these terminals. Thus, if the data for updating the virtual world cannot be transmitted from the managing entity to the terminal in the event of untimely breaks in the network or connection, an embodiment of the invention makes it possible to mask this from the other users.

An embodiment of the invention therefore resolves the problem of maintaining the immersive effect both for the user who undergoes the interruption and for those who do not undergo it directly. An embodiment of the invention can therefore be seen as a determining of a form of behavior suited to the representation during the modification of a state of data transfer between the user's terminal and the entity for managing the virtual environment.

In one embodiment of the invention, for example, at the time of an interruption of transfer, it is possible to make the representations of the users come into communication gradually and fictitiously in order to let a user who has just been subjected to an interruption think that he has not been disconnected. Thus, this user is simply made to believe that nobody has interacted with him because all the other representations are already fictitiously busy interacting with another representation. These instances of entering into fictitious forms of communication can be made as and when movements are made by the unconnected user (i.e. the one for whom the interruption has occurred) in such a way that he cannot come into contact with the other representations. Once the data transfer has been restored, the representations stop their fictitious communications and are available again.

According to one particular embodiment of the invention, said control method furthermore comprises a step for modifying a behavioral parameter of said representation as a function of said state of data transfer and of a topological location of said representation within said virtual world and said adaptation step takes account of said behavioral parameter to define said behavior of said representation.

Thus, an embodiment of the invention makes it possible to consider a behavioral parameter of the representation, i.e. a parameter used to describe at least one part of the behavior of the representation, namely a parameter which is itself a function of the status of data transfer between a client apparatus and a server apparatus and of the location of the representation within the virtual world. An embodiment of the invention thus makes it possible to control the behavior of the representation as a function of information other than just the occurrence of an interruption or a restoration of data transfer and thus greatly reduces the effect of disappointment felt by the user when the method is implemented at his terminal and by the other users, when the method is implemented by the managing entity to mask the interruption from the other users connected to the virtual environment.

According to one particular characteristic of an embodiment of the invention, said behavior takes the form of a movement along a dynamically computed path from a current point to a predetermined destination point.

Thus, when a modification of the state of transfer of data takes place (an interruption or a restoration), the user's representation performs a determined movement which brings the representation to a defined topological position in the virtual world. To this end, at the time of the modification of the state of data transfer, a path computation is done (either on the one hand by the managing entity to palliate the effect of the interruption for the other users of the virtual world or, on the other hand, by the terminal to palliate the effect of the interruption for the user being interrupted) in order to make the user's representation move from a current point to a predefined point as a function of the state of transfer.

This path makes it possible for keep to paths which would be naturally taken in real life, for example along a pavement and in avoiding fixed obstacles (such as streets, statues, signs etc) or moving obstacles (such as the representations of the other users). It can therefore be necessary to reupdate the path computation during the movement of the representation.

For example, this path is chosen so as to approach the destination zone in going out of the visual field of other users.

The behavior of the user's representation may thus consist in making movements. For example, it makes a hand gesture to greet the other users' representations or leaves in leaping or waving its arms in order to get to the destination point etc.

According to one particular characteristic of an embodiment of the invention, said state of transfer of data belongs to the group comprising at least:
insufficient transfer rate;
interruption;
in progress.

In a classic form of use, the state of data transfer is positioned at “in progress”. When an interruption occurs, the state of data transfer is positioned at “interrupted”. Then, when the state of data transfer is restored, the state of data transfer is positioned at “in progress”. The transfer rate (upwards to the managing entity and/or downwards to the terminal equipment) can also become insufficient for the representations to continue to be accurately animated in the virtual environment. In this case, the user's representation, despite the presence of a connection, may be animated automatically to ensure consistent behavior in the virtual environment. Indeed, it would be astonishing to a user to be situated in the presence of representations having spasmodic behavior patterns.

According to one particular characteristic of an embodiment of the invention, said behavioral parameter of said representation belongs to the group comprising at least:
connected;
disconnected;
being disconnected;
being reconnected.

Thus, an embodiment of the invention makes it possible to take account of several situations to control the user's representation. Indeed, when the state of the representation is the “being disconnected” state, the representation may be controlled in order to make it follow a specific movement enabling it to go to a waiting circuit, namely a circuit to which other representations of other users may already be in a waiting state. When the representation has reached this waiting circuit and if the state of data transfer is still interrupted, the behavioral parameter is modified to pass into the “disconnected” state. In this “disconnected” state, the movements and motions of the user's representations are computed in order to follow the waiting circuit in which the representations will act so long as their interruption persists. When the state of data transfer passes to “restored”, the behavioral parameter is initially positioned at “being reconnected” to enable the representation to leave the waiting circuit in which it is located and go to the topological position corresponding to the movements that the user will have ordered his representation to make during the interruption and that the managing entity passes on. Once this topological position is reached, the behavioral parameter is positioned at “connected”.

According to one particular embodiment of the invention, said path is a preprogrammed walking circuit in landscapes of the virtual environment according to “b-spline” curves.

According to one particular embodiment of the invention, said path is a tangential mathematical curve when said behavioral parameter of said representation is “being disconnected”.

Thus, such a use of a tangential curve make it possible to avoid having the user's representation make a right-angled entry into the topological waiting circle, which other users' representations are entering, but to adopt a tangential motion so that the penetration into the topological circle is as natural as possible.

According to one particular characteristic of an embodiment of the invention, said path is a catenary type mathematical curve when said behavioral parameter of said representation is set at “being reconnected”.

Thus, a use of a catenary curve of this kind, means that the user's representation does not have to be brought out of the topological circle at a right angle but can be given a movement so that the exit from the topological circle is as natural as possible.

According to one particular embodiment of the invention, the behavioural parameter also defines the degree of interaction of the representation with its environment. Thus for example when the behavioral parameter is at “being disconnected”, an embodiment of the invention allows the representation ‘A’ of the disconnected user to go to the waiting topological circle. However, if a user absolutely wishes to interact with the representation ‘A’ of this disconnected user and follows the representation ‘A’ in his path to the topological waiting circle (as in a form of harassment or stalking), an embodiment of the invention makes it possible to take account of this state of pursuit and accelerate the pace of the representation ‘A’ so that his speed is greater than the maximum speed of the “stalking” representation.

In yet another example, when the behavioral parameter is “disconnected” and when the “stalking” user tries to enter into communication with the representation ‘A’ which is in the waiting circuit, an embodiment of the invention enables this representation ‘A’ to be made to adopt another behavior in detecting the attempt to make contact. For example, when the representation of the “stalker” user tries to make contact, the representation ‘A’ may receive a “fictitious” telephone call or enter into fictitious communication which does not allow the “stalking” user to continue his attempt to make contact.

An embodiment of the invention also relates to a device for controlling a user's representation in a virtual world.

According to an embodiment of the invention, such a device comprises:
means of continuous supervision of a state of transfer of data between a terminal of said user and an entity for managing said virtual environment;
means for adapting a behavior of said representation following a modification of said state of data transfer.

Such a device may take the form of a managing entity or be integrated into it. This device may also take the form of a user's representation or be integrated into it.

According to another aspect, an embodiment of the invention also concerns a computer program product downloadable from a communications network and/or recorded on a computer-readable carrier and/or executable by a microprocessor and comprising program code instructions for executing the method for controlling as described here above.

### BRIEF DESCRIPTION OF THE DRAWINGS

Other features and advantages shall appear more clearly from the following description of a particular embodiment given by way of a simple, illustrative and non-restrictive example and from the appended drawings, of which:

FIG. 1 presents the method of an embodiment of the invention;

FIG. 2 illustrates an example of a general system for implementing the method of an embodiment of the invention;

FIG. 3 presents the main steps of the method according to one embodiment of the invention in a system such as the one shown in FIG. 2;

FIG. 4 presents the structure of a transfer device implementing the transfer method according to one particular embodiment of the invention.

### DETAILED DESCRIPTION OF ILLUSTRATIVE EMBODIMENTS

### 1. Reminder of the Principle of an Embodiment of the Invention

An embodiment of the invention is used to maintain the immersive effect of a virtual environment even when the physical apparatuses that participate in the implementation of the virtual environment undergo untimely interruptions or significant drops in data transfer rates.

An embodiment of the invention thus provides a solution to the problem of disappointment that can be caused by untimely interruptions in data transfers. Furthermore, an embodiment of the invention resolves this problem naturally. Indeed, an embodiment of the invention furthermore offers the advantage of continuing the natural rendering of the virtual environment even when there is an interruption in data transfer between a user terminal and the entity managing the virtual environment.

The general principal of an embodiment of the invention relies on the determining of an appropriate behavior of the representations during a modification of a state of data transfer between the user's terminals and the entities managing the virtual environment.

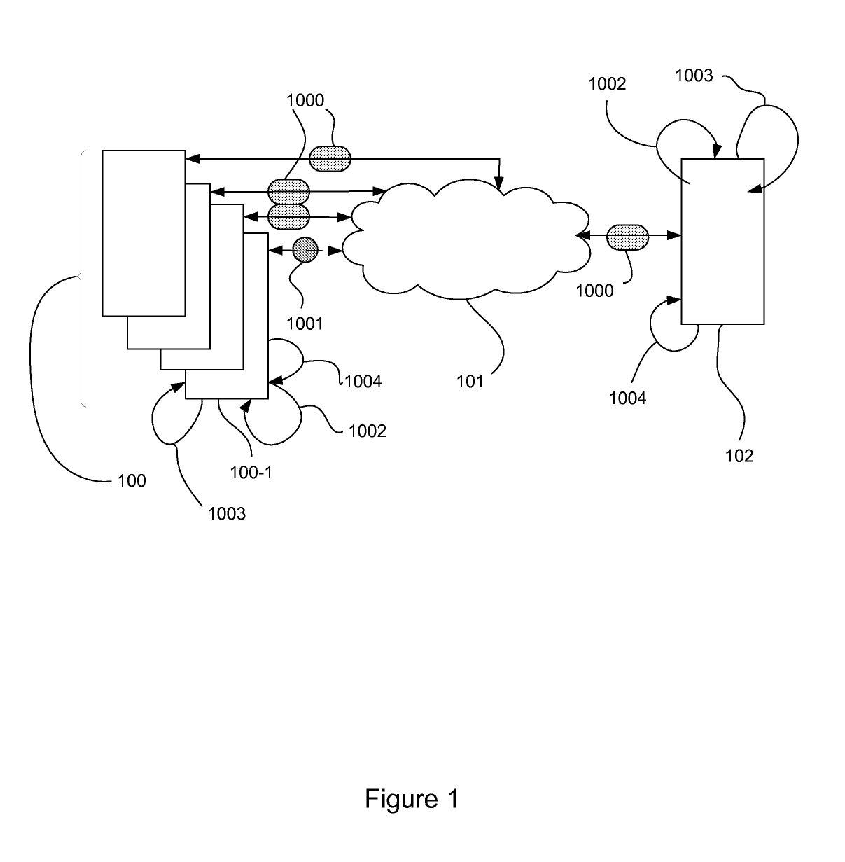

This general principle is presented with reference to FIG. 1.

The solution proposed consists in monitoring (1000) communications between common apparatuses (terminals 100 of the users and the entity for managing the virtual environments 102) through the network 101. When everything is working normally, the behavior of the users' representations is defined by the “connected” behavioral parameter. When this behavioral parameter has the value “connected”, the movements and motions of a user representation in a user's terminal 100 are commanded by the information items that come from this terminal 100 of the user who possesses the user representation.

When an interruption occurs (1001) for a terminal (for example 100-1), the behavior of the user's representations whose data transfer has been interrupted passes, by means of the behavioral parameter, from a “connected” state to a “being disconnected” state. In this “being disconnected” state, the movements and motions of the users' representations are computed (1002) so as to bring them to move automatically to go to a waiting circuit (in the virtual environment). A waiting circuit is a topologically programmed or computed path, equivalent to a circle in the virtual world.

When the user representation has reached this waiting circuit, its behavior parameter passes from the “being disconnected” state to the “disconnected” state. Using this “disconnected” behavior parameter, the movements and motions of the users' representations are computed (1003) in order to follow the waiting circuit. The waiting circuit could for example be a topological circle, and the users' representations can remain indefinitely on this path.

When the interruption stops, the behavior parameter of the users' representations passes from the “disconnected” state to the “being reconnected” state. Using this “being reconnected” value, the movements and motions of the users' representations are computed (1004) so as to make them move automatically to come into the position commanded by information items that come from the terminals of the users who possess the representations for which the data transfer interruption is stopping.

When the user representation has come to this position, its behavioral parameter passes from the “being reconnected” state to the “connected” state.

This illustration with the help of FIG. 1 shows that the method of an embodiment of the invention can equally well be implemented within the terminal (100-1), which undergoes the interruption, to move representations of other users.

The method of an embodiment of the invention can also be implemented within the managing entity (102) in order to carry out the animation of the representation of the user for whom the terminal is undergoing interruptions. This interruption can be total or partial and can result in a total absence of a transfer of data or a diminishing of the available transfer rate.

In variants of implementation, the junctions may follow particular paths. For example, to enter a topological waiting circle, it is more natural for the representation to penetrate it by a tangent of the topological circle rather than perpendicularly to the circle.

In other variants of implementation, the waiting circuits can follow particular paths such as walking paths in the virtual environment.

Such particular paths are sequences of locations which define the places through which the users' representation must pass and the positions that they must take (arms, head etc). The immersion program interpolates the values between these points to fluidly display the movements and motions of the representations.

Other paths may be envisaged as a function of the topology of the virtual environment:
pre-programmed circuits in the landscapes of the virtual world according to b-spline curves;
tangential mathematical curves for use when the behavior parameter has the value “being disconnected”;
catenary mathematical curves for use when the behavioral parameter has the “being reconnected” value.

The catenary type curve can also be applied particularly well when the destination moves, in fact when it is a destination that moves at constant speed, (for example if it is another representation of another user to be reached). To reach a representation in motion naturally, this curve will be used.

In other variants, the behavior of the representations of users from whom it is no longer possible to receive data can be linked to their previous activities. For example, if a first user had been in contact (for a communication for example) with a second user, it can be the case that the behavior of these two representations, for a third user subjected to an interruption of data transfer, does not change. In other words, for this third user, the other two representations would “fictitiously” continue the actions that they were in the process of conducting together.

Here below, we will present especially the case of an implementation of the method of an embodiment of the invention in making the representations move towards a waiting topological circle. It is clear however that one or more embodiments of the invention cannot be limited to this particular application.

### 2. Description of An Embodiment

In this embodiment, we present the implementation of the method to the putting into motion of representations towards a topological waiting circle.

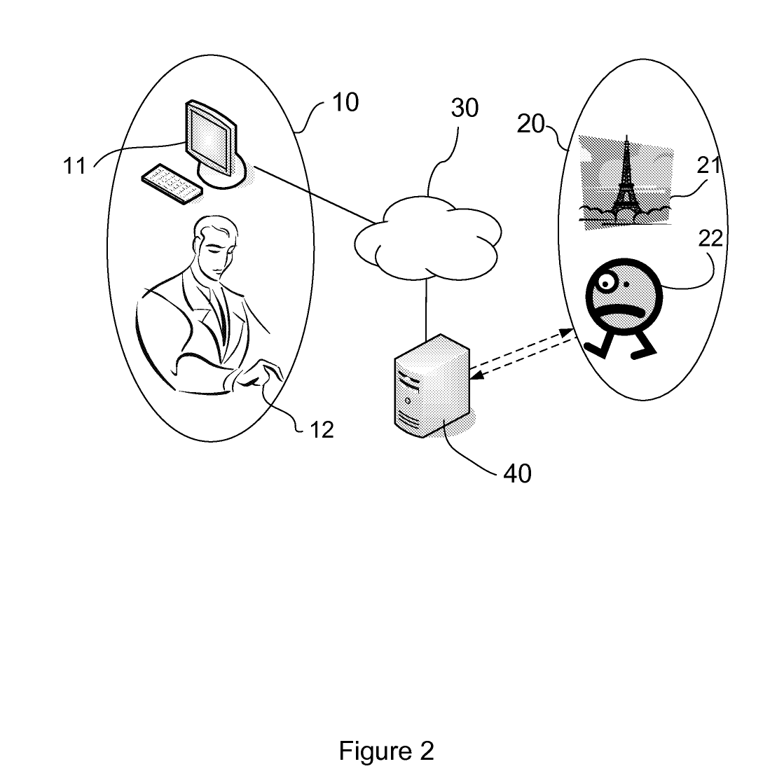

Referring now to FIG. 2, we present with reference to this embodiment, the general principal of implementation.

In the real world 10, each user 12 accesses a virtual world 20 by means of an immersion terminal 11 (such as a computer, but it is possible to envisage any other immersion system, for example a telephone, a PDA, a 3D head-mounted display etc).

Each virtual world 20 comprises:
one or more virtual spaces 21;
users' representations (or avatars) 22 representing users 12 from the real world;
a communications network 30 enabling the immersion terminals 11 to communicate with one another as well as with servers 40;
servers 40, or control entities installed on servers fulfilling a role of coordination, distribution and storage.

In the virtual world 20, a user 12 of the real world 10 is represented by his avatar 22 in the virtual world 20. In the real world 10, the user 12 drives his representation 22 and sees the visual field perceived by this representation 22 by means of the immersion terminal 11.

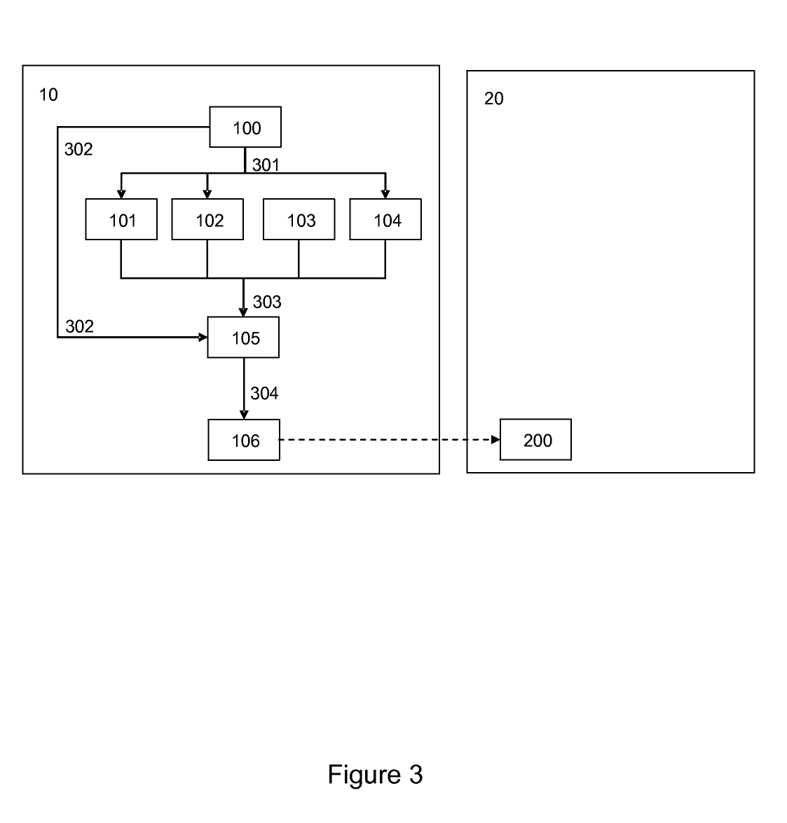

Referring now to FIG. 3, we present an embodiment of the method for the putting into motion of representations towards a topological waiting circle.

In the virtual world 20, a user's representation 200 performs the motions and movements of a user that commands it.

In the real world 10, a receiving device 100 receives common apparatuses (of the managing entities of the virtual world for example), the information items 301 pertaining to motion and movement of the avatars (in the form of data transferred in real time between apparatuses). It also incorporates a system for monitoring data transfer and provides the module 105 with the signal 302 for interrupting the reception of the information.

The module 101 determines the path according to the information 301 received from the common apparatuses which pass on the motions and movements of the user's representations. This is the acting module when the behavioral parameter has the “connected” value.

The module 102 determines the path, according to the final information 301 received just before the interruption of transfer, for going to the waiting circuit. This is a module acting when the behavioral parameter has the value “being disconnected”.

The module 103 determines the path of the representations on the waiting circuit. This is the acting module when the behavioral parameter has the value “disconnected”.

The module 104 determines the path for going to the position indicated by the information items 301 received from the common apparatuses which pass on the motions and movements of the users' representations. This is the acting module when the behavioral parameter has the “being reconnected” value.

The module 105 chosen as a function of the interruption signal 302 and of the behavioral parameter in progress, chooses the position 303 that is received from the modules 101 to 104. It transmits the chosen information on position 304 to the module 106.

The driven interface 106 controls the position of motions and movements of the user's representation 200 in the virtual world 20.

### 3. Other Optional Characteristics And Advantages

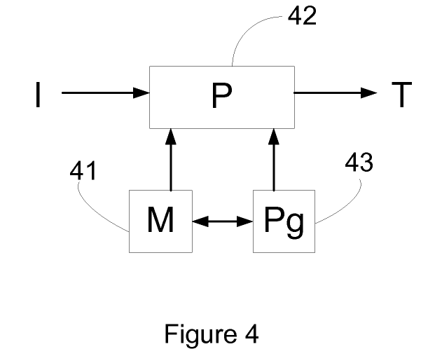

Referring now to FIG. 4, we present one embodiment of a behavior control device according to an embodiment of the invention.

A control apparatus such as this comprises a memory 41 constituted by a buffer memory, a processing unit 42 equipped for example with a microprocessor P and driven by the computer program 43 implementing the method for display and/or deletion according to an embodiment of the invention.

At initialization, the code instructions of the computer program 43 are loaded for example into a RAM and then executed by the processor of the processing unit 42. At input, the processing unit 42 receives at least one characteristic of the state of data transfer at input. The microprocessor of the processing unit 43 implements the steps of the method for controlling described here above, according to the instructions of the computer program 43 to decide whether a user's representation must go to the waiting circle. To this end, the device for managing comprises, in addition to the buffer memory 41, means for obtaining a behavioral parameter of the representation, means for modifying this behavioral parameter as a function of the state of data transfer, means for computing the path of different user representations. These means are driven by the microprocessor of the processor unit 42.

Such a device is especially a centralized server managing the different servers and control entities in a system comprising a plurality of virtual worlds. Such a device may also be integrated into a user's terminal in order to enable this user to continue to benefit from the immersive effect of the virtual environment even in the event of an interruption in data transfer.

Although the present disclosure has been described with reference to one or more examples, workers skilled in the art will recognize that changes may be made in form and detail without departing from the scope of the disclosure and/or the appended claims.

1. A method for controlling a user's representation in a virtual environment, wherein the method comprises:
continuously supervising of a state of data transfer between a terminal of said user and an entity for managing said virtual environment; and
adapting a behavior of said representation following a modification of said state of data transfer.

2. The method for controlling according to claim 1, wherein the method furthermore comprises:
modifying a behavioral parameter of said representation as a function of said state of data transfer and of a topological location of said representation within said virtual world;
and wherein the step of adapting takes account of said behavioral parameter to define said behavior of said representation.

3. The method according to claim 1, wherein said behavior corresponds to a movement along a dynamically computed path from a current point to a predetermined destination point.

4. The method according to claim 2, wherein said state of data transfer belongs to a group of states comprising at least:
insufficient transfer rate;
interruption; and
in progress.

5. The method according to claim 2, wherein said behavioral parameter belongs to a group of parameters comprising at least:
connected;
disconnected;
being disconnected; and
being reconnected.

6. The method according to claim 3, wherein said path is a pre-programmed walking circuit in landscapes of the virtual environment according to “b-spline” curves.

7. The method according to claim 5, wherein said behavior corresponds to movement along a dynamically computed path from a current point to a predetermined destination point and said dynamically computed path is a tangential mathematical curve when said behavioral parameter of said representation is “being disconnected”.

8. The method according to claim 5, wherein said behavior corresponds to movement along a dynamically computed path from a current point to a predetermined destination point and said dynamically computed path is a catenary type mathematical curve when said behavioral parameter of said representation is set at “being reconnected”.

9. A device for controlling a user's representation in a virtual world, wherein the device comprises:
means of continuously supervising of a state of transfer of data between a terminal of said user and an entity for managing said virtual environment; and
means for adapting a behavior of said representation following a modification of said state of data transfer.

10. A computer program product recorded on a computer-readable carrier and executable by a microprocessor and comprising program code instructions for executing a method for controlling a user's representation in a virtual environment when the instructions are executed on a computer, wherein the method comprises:
continuously supervising a state of data transfer between a terminal of said user and an entity for managing said virtual environment; and
adapting a behavior of said representation following a modification of said state of data transfer.
